(19) United States
(12) Patent Application Publication
(10) Pub. No.: US 2011/0283830 A1
(43) Pub. Date: Nov. 24, 2011

(54) CONCENTRIC SLAVE CYLINDERS TO ACTUATE CLUTCHES ON A DUAL CLUTCH TRANSMISSION

(75) Inventors: Nicolas RENARD, Karlsruhe (DE); Pierre STENGEL, Wolxheim (FR); Nicolas FUNALOT, Souffelweyersheim (FR); Vincent GAUTIER, Westhouse (FR); Pascal MOMAL, Velizy Villacoublay (FR)

(73) Assignee: GM GLOBAL TECHNOLOGY OPERATIONS, INC., Detroit, MI (US)

(21) Appl. No.: 12/907,520

(22) Filed: Oct. 19, 2010

(30) Foreign Application Priority Data
Oct. 19, 2009 (GB) 0918281.7

(51) Int. Cl. F16D 47/06; F16H 37/06; F16D 25/06

(52) U.S. Cl. 74/664; 192/48.616; 74/665 A

(57) ABSTRACT

A clutch actuation device is provided for dual clutches of a Dual Clutch Transmission. The clutch actuation device includes, but is not limited to a cylinder assembly that is substantially fixed to a clutch casing. The cylinder assembly includes, but is not limited to an inner annular chamber, an outer annular chamber, an inner annular piston, and an outer annular piston. The inner annular chamber is intended for receiving liquid under pressure and includes, but is not limited to an inner inlet. Similarly, the outer annular chamber is intended for receiving liquid under pressure and includes, but is not limited to an outer inlet. The outer annular chamber surrounds a portion of the inner annular chamber. The inner annular piston is slidably disposed in the inner annular chamber for actuating a first clutch disc whilst the outer annular piston is slidably disposed in the outer annular chamber for actuating a second clutch disc.

### CROSS-REFERENCE TO RELATED APPLICATION

This application claims priority to British Patent Application No. 0918281.7, filed Oct. 19, 2009, which is incorporated herein by reference in its entirety.

### TECHNICAL FIELD

This application relates to an actuation for a Dual Clutch Transmission (DCT). In particular, it relates to a hydraulic system for the DCT.

### BACKGROUND

A Double Clutch Transmission comprises two input shafts that are connected to and are actuated by two clutches separately. The Double Clutch Transmission is also known as Dual Clutch Transmission. The two clutches are often combined into a single device that permits actuating any of the two clutches at a time. The two clutches are connected to two input shafts of the DCT separately for providing driving torques.

At least one object of this application is to provide an improved clutch actuation that is cost efficient. In addition, other objects, desirable features, and characteristics will become apparent from the subsequent summary and detailed description, and the appended claims, taken in conjunction with the accompanying drawings and this background.

### SUMMARY

The application provides a clutch actuation device for dual clutches of a Dual Clutch Transmission. The clutches act as coupling devices between a combustion engine and the Dual Clutch Transmission. The Dual Clutch Transmission comprises gearwheels with teeth around its outer edges. The gearwheels controls mechanical power from the combustion engine to wheels of the vehicle and provides speed-changing gears for a user of the vehicle. It is believed that a dual clutch activation device that comprises a first clutch activation unit and a second clutch activation unit can be smaller when one activation unit encloses another.

The clutch actuation device includes a slave cylinders assembly that is enclosed by a clutch casing or housing and that is secured to the clutch casing. The concentric cylinders assembly includes an inner chamber and an outer chamber. The chamber includes a bore that relates to an either inner space or hole of a cylinder or to an inner space between an outer cylinder and an inner cylinder that is enclosed by the outer cylinder.

The inner chamber is intended for receiving a working liquid under pressure and it comprises an inner inlet or port for receiving the working liquid. The inlet comprises a passage for a flow of the liquid. The liquid is usually in the form of lubricating oil with the appropriate viscosity and high temperature tolerance. Similarly, the outer chamber is used for receiving liquid under pressure. The outer chamber also comprises an outer inlet for receiving the liquid. In practice, a portion of the liquid may be in the form of a gas. In a special embodiment, the application works with one or more gases that replace the liquid.

Structurally, the inner chamber and the outer chamber are arranged such that either a portion of the inner chamber or the entire inner chamber is surrounded by the outer chamber. The inner chamber and the outer chamber usually share the same axis. In other words, the inner chamber and the outer chamber are arranged usually in a concentric manner. The outer chamber usually has an annular shape that is defined between an outer cylinder and an inner cylinder. It should be understood that the term “annular”, as used here, refers essentially to a band with an essentially circular or oval shape. The inner chamber can have the annular shape or a cylindrical shape.

The concentric cylinder assembly further includes an inner piston and an outer piston. The piston refers to a sliding body within the chamber. The inner piston is slidably disposed in the inner chamber for actuating or for moving a first clutch disc for the Dual Clutch Transmission. The clutch disc selectively couples or connects to the Dual Clutch Transmission. The liquid acts on or engages the inner piston to actuate the first clutch disc. In the same manner, the outer piston is slidably disposed in the outer chamber for actuating a second clutch disc for the Dual Clutch Transmission. The liquid acts on the outer piston to actuate the second clutch disc. In particular, the outer piston surrounds either a portion of the inner piston or the entire inner piston. The inner piston and the outer piston usually share the same axis. In other words, the inner piston and the outer piston are arranged usually in a concentric manner. The outer piston usually has the annular shape whilst the inner piston can have the annular shape or a cylindrical shape.

The concentric structure of the cylinder assembly enables the clutch actuation device to require or to take up less space as compared to other dual clutch actuation implementation. The clutch actuation device can include a hydraulic circuit that comprises a liquid source, a pump, and an operating valve. The pump is connected to the liquid source and to the operating valve. In particular, the liquid source is positioned usually in a lower part of the Dual Clutch Transmission. The liquid source stores or receives liquid for later use by another component. In application, the liquid source can include a sump.

The pump supplies the liquid under pressure from the liquid source to the outer annular chamber via the outer inlet and via the operating valve and to the inner annular chamber via the inner inlet and via the operating valve. The operating valve regulates the flow of liquid. The regulation may stop the flow or restrict the flow such that the pressure of the liquid changes. Operationally, the liquid flows through the operating valve to the outer annular chamber and to the inner annular chamber. A pressure of the liquid allows both the inner annular chamber and the outer annular chamber to be filled with the liquid. Further, the operating valve controls the pressure of the liquid to engage selectively one piston and to release of the other piston. The selected piston can refer to the outer annular piston or to the inner annular piston. The selected chamber receives a higher clutch actuation pressure for actuating the corresponding selected piston and clutch.

The clutch actuation device can also include a pressure relief valve and a conduit means. The conduit means provides liquid passageway and it is connected to a discharge side of the pressure relief valve and to the liquid source. The relief valve maintains a minimum fluid pressure level. The relief valve is arranged with the operating valve such that a predetermined clutch actuation pressure is established in the chamber of the engaged piston whilst a relatively lower pressure is established in the chamber of the unengaged piston. The lower pressure allows the chamber of the unengaged piston to be filled or be occupied with liquid.

The clutch actuation device can comprise an inner annular piston seal and an outer annular piston seal. The inner annular piston seal is fixed to one end of the inner annular piston whilst the outer annular piston seal is fixed to one end of the outer annular piston. Functionally, the inner annular piston seal prevents the liquid in the inner annular chamber from leaking. Put differently, the annular piston seal covers any crack or opening between the annular piston and the annular chamber such that the liquid does not flow out through the opening. Similarly, the outer annular piston seal also prevents the liquid in the outer annular chamber from leaking.

The application provides a Dual Clutch Transmission. The Dual Clutch Transmission includes a first clutch disc, a second clutch disc, and the above-mentioned clutch actuation device. The first clutch disc is connected to an inner input shaft. One or more gearwheels are provided on the inner input shaft. The gearwheels have teeth around its outer edges for controlling mechanical power from a combustion engine to one or more wheels of a vehicle. Likewise, the second clutch disc is connected to an outer input shaft. One or more gearwheels are provided on the outer input shaft.

The inner input shaft and the outer input shaft are arranged such that either a portion of the inner input shaft or the entire inner input shaft is surrounded by the outer input shaft. Put differently, the inner input shaft and the outer input shaft share the same axis. In practice, the clutch actuation device selectively actuates the first clutch disc and the second clutch disc to engage a combustion engine.

The application provides a powertrain and a vehicle with the power train. The powertrain is used for transmitting mechanical power to one or more wheels of the vehicle. The powertrain includes an internal combustion engine and the above-mentioned Dual Clutch Transmission. The Dual Clutch Transmission is engageable or is connectable to the internal combustion engine. The vehicle includes the powertrain and one or more wheels that are selectively connected to the powertrain.

The application provides a further clutch actuation device for a Dual Clutch Transmission, wherein the clutch actuation device includes a concentric cylinder assembly. In particular, the cylinder assembly includes a first hydraulic motor and a second hydraulic motor. The hydraulic motor is used to convert hydraulic pressure to linear displacement. The first hydraulic motor actuates or moves a first clutch disc of the Dual Clutch Transmission whilst the second hydraulic motor actuates a second clutch disc of the Dual Clutch Transmission based on user input. Further, the first hydraulic motor and the second hydraulic motor are arranged such that either one part of the first hydraulic motor or the entire first hydraulic is enclosed or is surrounded by the second hydraulic motor. The first hydraulic motor and the second hydraulic motor usually share the same axis. This concentric arrangement has an advantage of smaller size, since one hydraulic motor is enclosed within another hydraulic motor.

In many cases, the first hydraulic motor comprises an inner liquid chamber and an inner piston that is disposed in the inner liquid chamber. Similarly, the second hydraulic motor comprises an outer liquid chamber and an outer piston that is disposed in the outer liquid chamber. Either one part of the inner chamber or the entire inner chamber is enclosed or is surrounded by the outer chamber. The cylinder assembly is usually placed inside a clutch casing, wherein it is fixed to the clutch casing.

In short, the application provides a clutch assembly that enables clutch actuation for a Dual Clutch Transmission using hydraulic energy.

The clutch assembly comprises a concentric slave cylinder assembly that uses a hydraulic actuation unit for actuating two clutches of the Dual Clutch Transmission. The concentric slave cylinders assembly is located in a clutch casing or housing and it is fixed to the clutch casing. The concentric slave cylinders assembly has chambers that comprise pistons to apply as well as to release the clutches through anti-friction elements, such as apply or release bearings. Working liquid, such as oil, is injected under adequate pressure into the chambers of the clutch assembly.

The clutch assembly has an advantage of a smaller size since the clutch actuation mechanism neither uses a hydraulic actuation system that uses levers and pistons nor uses an electro-mechanical actuation system that uses levers and electric motors. As a result, the clutch assembly can be smaller. Because of this advantage, the clutch assembly can also have a lower cost.

In the following description, details are provided to describe embodiments of the application. It shall be apparent to one skilled in the art, however, that the embodiments may be practiced without such details.

### BRIEF DESCRIPTION OF THE DRAWINGS

The present invention will hereinafter be described in conjunction with the following drawing figures, wherein like numerals denote like elements, and

FIG. 1 illustrates a three-dimensional cross-sectional view of an embodiment of a clutch actuation device;

FIG. 2 illustrates a two-dimensional view cross-sectional of the clutch actuation device of FIG. 1; and

FIG. 3 illustrates a schematic view of a hydraulic system for operating the clutch actuation device of FIG. 1 and FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

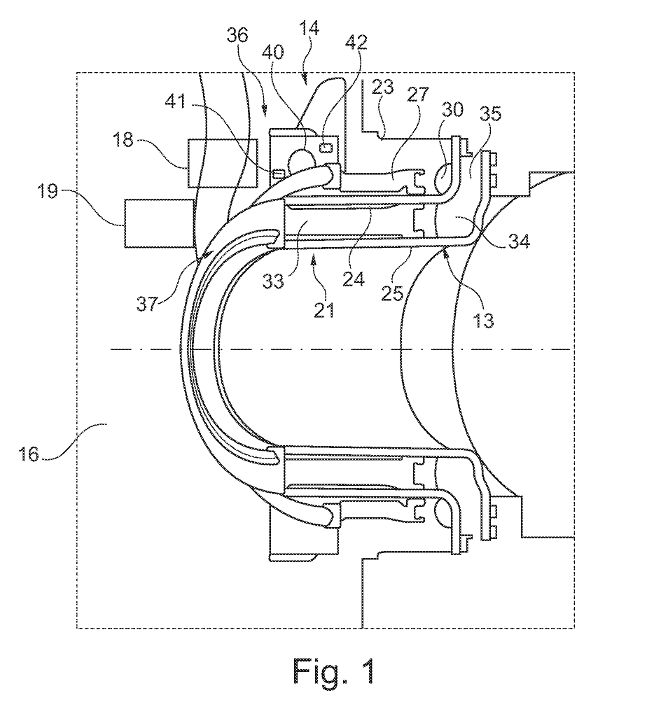

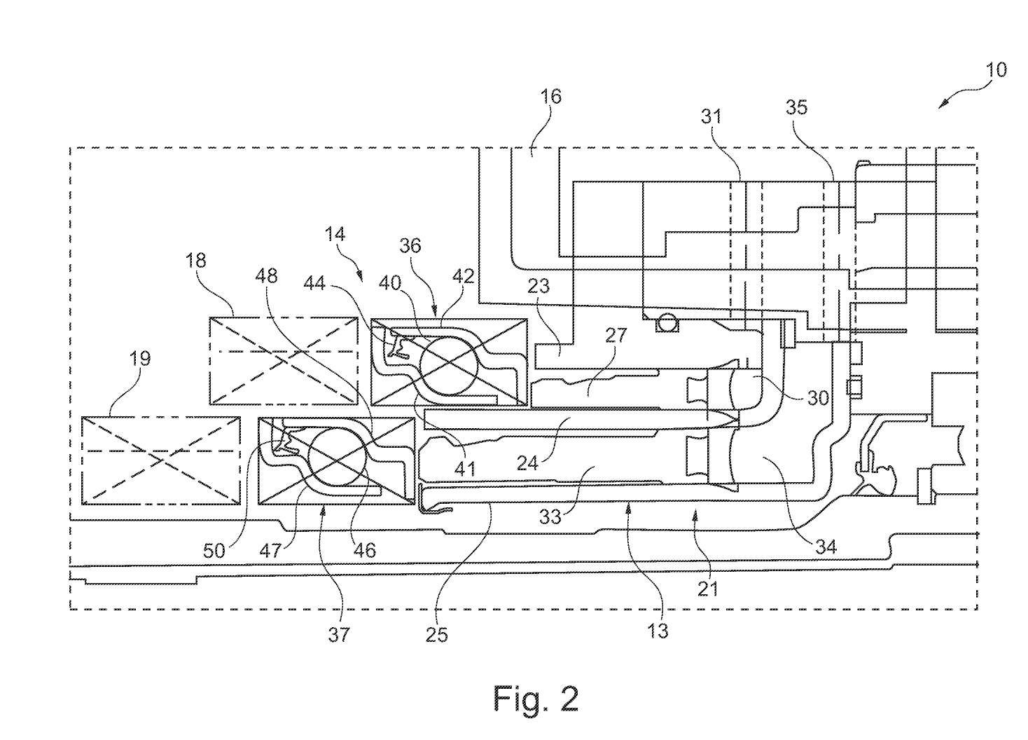

FIG. 1 and FIG. 2 depict cross-sectional views of a device 10 for actuating dual clutches of a Dual Clutch Transmission. The dual clutches allow a turning force from a combustion engine to be sent to a powertrain or to wheels of a vehicle. The Dual Clutch Transmission has gears that comprise wheels with teeth around outer edges of the wheels for controlling mechanical power from the combustion engine to the powertrain or to the wheels of the vehicle. The vehicle provides a means of transport.

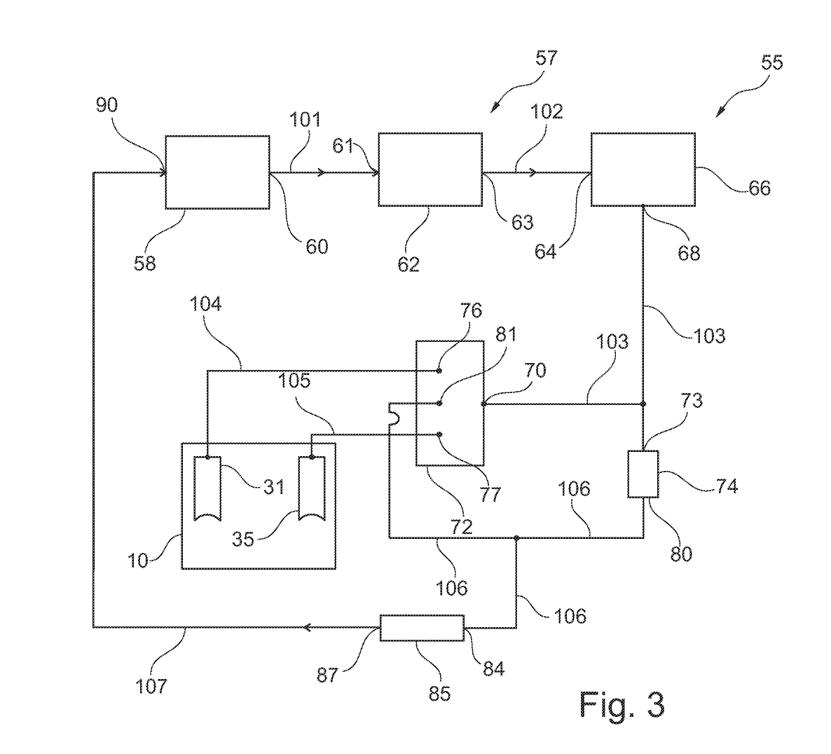

A control member 57, as shown in FIG. 3, actuates the clutch actuation device 10 for engaging or for acting on a first clutch release device 18 and a second clutch release device 19. The term “acting” is also called “bearing”. In particular, the drive member 14 is adapted to operate on clutch release devices 18 and 19, when the maneuvering member 13 acts or urges on the drive member 14 in the axial direction. The maneuvering member 13 is adapted for engaging or for acting by the control member 57. The clutch actuation device 10 comprises a maneuvering member 13 and a drive member 14. The maneuvering member 13 is placed towards a gearbox side of the vehicle whilst the drive member 14 is placed towards a motor or a clutch side of the vehicle. The gearbox is also known as transmission casing. The motor is also known as combustion engine.

Referring to the maneuvering member 13, the maneuvering member 13 comprises a concentric slave cylinders assembly 21 with a set of pistons. The concentric slave cylinders assembly 21 is fixed or is secured to a clutch casing 16 or housing of the dual clutches. The clutch casing 16 encloses inner parts of the dual clutches and the concentric slave cylinders assembly 21. The concentric arrangement of the slave cylinders assembly 21 allows the clutch actuation device 10 to be implemented with less space as compared to other implementation arrangement or design.

The slave cylinders assembly 21 includes a first cylinder 23, a second cylinder 24, and a third cylinder 25. These cylinders 23, 24, and 25 share a same axis. The first cylinder 23 surrounds the second cylinder 24 as well as the third cylinder 25 whilst the second cylinder 24 surrounds the third cylinder 25.

An outer annular piston 27 is disposed slidably between the first cylinder 23 and the second cylinder 24. The outer annular piston 27 has a first end and a second end. The first end is directed towards the gearbox side whilst the second end is directed towards the clutches side. The first end of the outer annular piston 27 together with the first cylinder 23 and the second cylinder 24 form an outer annular chamber 30. The outer annular chamber 30 has an outer inlet 31. The first end of the outer annular piston 27 also forms essentially a hermetic seal with the first cylinder 23 and with the second cylinder 24 such that any liquid in the outer annular chamber 30 does not leak towards the second end of the outer annular piston 27. In a special embodiment, the hermetic seal is achieved by providing the first end of the outer annular piston 27 with a rubber seal. Further, the second end of the annular piston 27 is adapted for engaging or for acting on the drive member 14. Similarly, an inner annular piston 33 is disposed slidably between the second cylinder 24 and the third cylinder 25. The inner annular piston 33 has a first end and a second end. The first end is directed towards the gearbox side whilst the second end is directed towards the clutches side.

The first end of the inner annular piston 33 together the second cylinder 24 and the third cylinder 25 form an inner annular chamber 34. The inner annular chamber 34 has an inner inlet 35. The first end of the inner annular piston 33 also forms essentially a hermetic seal with the second cylinder 24 and with the third cylinder 25 such that any liquid in the inner annular chamber 34 does not leak to the second end of the inner annular piston 33. In an alternative embodiment, the hermetic seal is achieved by placing a rubber seal on the inner annular piston 33. Moreover, the second end of the inner annular piston 33 is adapted for engaging or for acting on the drive member 14. Further, the outer annular piston 27 surrounds the inner annular piston 33 such that the outer annular piston 27 and the inner annular piston 33 share the same axis. Likewise, the outer annular chamber 30 surrounds the inner annular chamber 34 so that the outer annular chamber 30 and the inner annular chamber 34 share the same axis. In a generic sense, the inner annular piston 33 and the second annular chamber 24 functions as part of a hydraulic motor. The outer annular piston 27 and the outer annular chamber 30 also functions as part of a hydraulic motor.

Referring to the drive member 14, the drive member 14 includes a first clutch bearing 36 and a second clutch bearing 37. The clutch bearings 36 and 37 are also known as clutch release bearings. The first clutch bearing 36 includes a ball bearing 40 and two generally annular members. The annular members comprises an inside ring 41 and an outside ring 42 that together encloses the ball bearing 40. A deflector 44 is placed between one end of the inside ring 41 and one end of the outside ring 42. The outside ring 42 is adapted for engaging or for acting by the second end of the outer annular piston 27 of FIG. 2. The inside ring 41 is adapted to bear on the clutch release device 18, when the outside ring 42 is acted on by the outer annular piston 27. In a similar manner, the second clutch bearing 37 comprises a ball bearing 46, an inside ring 47 and an outside ring 48. The inside ring 47 and the outside ring 48 surrounds the ball bearing 46. A deflector 50 is positioned between one end of the inside ring 47 and one end of the outside ring 48. The outside ring 48 is adapted for engaging or for acting by the second end of the inner annular piston 33 of FIG. 2. The inside ring 47 is adapted to bear on the clutch release device 19, when the outside ring 48 is acted on by the inner annular piston 33. Moreover, the ball bearings 40 and 46 each comprises a ball cage, which is not shown, for retaining or keeping the ball bearings 40 and 46 in position. Lubricating grease is employed on the ball bearings 40 and 46 to ensure its anti-friction characteristic.

FIG. 3 shows a schematic view of a hydraulic system 55 for operating the clutch actuation device 10 of FIGS. 1 and 2. The hydraulic system 55 does not include levers. The hydraulic system 55 includes a control member 57. The control member 57 includes a gear pump 66 for controlling or for actuating the clutch actuation device 10 using an operating valve 72 and a relief valve 74. Specifically, the control member 57 comprises a sump 58. The sump 58 is disposed in a lower portion of a transmission casing or housing. A first conduit 101 connects a sump outlet 60 to a filter inlet 61 whilst a second conduit 102 connects a filter outlet 63 to an inlet 64 of the gear pump 66. A third conduit 103 connects a gear pump outlet 68 to an inlet 70 of the operating valve 72 and to an inlet 73 of the relief valve 74.

A fourth conduit 104 connects a first operating valve outlet 76 to the outer inlet 31 of the outer annular chamber 30 whilst a fifth conduit 105 connects a second operating valve outlet 77 to the inner inlet 35 of the inner annular chamber 34 of the slave cylinders assembly 21. A sixth conduit 106 connects a relief valve outlet 80 to an operating valve inlet 81 and to an inlet 84 of a cooler 85. A seventh conduit 107 connects a cooler outlet 87 to a sump inlet 90.

In practice, the sump 58 contains or holds a working liquid, which usually is in the form of lubricating oil. The working liquid provides a medium for transmitting clutch actuation pressure to the clutch actuation device 10. The outer inlet 31 of the outer annular chamber 30 and the inner inlet 35 of the inner annular chamber 34 of the clutch actuation device 10 of FIG. 1 and FIG. 2 receive the clutch actuation pressure.

The lubricating oil is drawn from the sump 58 through the filter 62 by the gear pump 66 and it is forced under pressure through the relief valve 74 and through the operating valve 72 to the clutch actuation device 10. The filter 62 removes contaminants or foreign particles from the working liquid to keep these contaminants from reaching the relief valve 74 and the operating value 72. The relief valve 74 is arranged or configured such that the relief valve 74 allows a relatively low pressure, for example, about five pounds per square inch, to be applied or transmitted to the clutch actuation device 10. This insures that the annular chambers 30 and 34 are filled constantly with the lubricating oil. The constant filling compensates for any leakage and allows for a rapid increase in the pressure of the lubrication oil in either outer annular chamber 30 or inner annular chamber 34 upon movement or activation of pressure by the operating valve 72.

When the Dual Clutch Transmission is in a neutral state, the operating valve 72 is also arranged to be in a neutral state. The neutral state is also called a neutral position. In the neutral state, the operating valve 72 does not transmit a pressure to the clutch actuation device 10. In this state, the clutches of the Dual Clutch Transmission are not engaged. In a case of a vehicle that has the Dual Clutch Transmission, a combustion engine of the vehicle is not connected to powertrain or to wheels of the vehicle, since the clutches are not engaged.

If a forward or a reverse gear of the Dual Clutch Transmission is selected, the pressure from the operating valve 72 is increased to actuate the appropriate clutch that corresponds to the selected gear. The selected gear relates to a particular gear ratio of the Dual Clutch Transmission. One gear would correspond to only one clutch of the dual clutches of the Dual Clutch Transmission. In most implementation, the forward gear of an odd number relates to one clutch of the dual clutches whilst the forward gear of an even number relates to the other clutch of the dual clutches.

The actuation of the clutch is achieved by transmitting the actuating clutch pressure from the gear pump 66, to the appropriate outlet 76 or 77 of the operating valve 72 via the lubricating oil. The actuating clutch pressure is also transmitted to the corresponding annular chamber 30 or 34. The corresponding annular chamber 30 or 34 experiences an increased rapidly pressure to the actuating clutch pressure of, for example, about one hundred pounds per square inch, while pressure of the other non-selected annular chamber 30 or 34 remains the low pressure of about five pounds per square inch.

The clutch actuation pressure is then exerted on the corresponding annular piston 27 or 33. This pressure actuates or moves the corresponding annular piston 27 or 33 to bear on the corresponding clutch bearing 36 or 37, and thus on the corresponding clutch release device 18 or 19 for engaging the appropriate selected clutch. If the clutch actuation pressure is removed or is reduced from the annular chamber 30 or 34, the corresponding clutch of the dual clutches is also released. Lubricating oil that does not reach the clutch actuation device 10 is passed through the cooler 85 en route to the sump 58, thus completing the cycle. In a generic sense, the embodiment can include a coupling means to provide an appropriate axial linkage between the drive member 14 and the maneuvering member 13. Moreover, the outer annular piston 27 can comprise a transverse flange, which may be a simple collar, for engaging or for bearing on the first clutch bearing 36. The first clutch bearing 36 can comprise a radial rim and an axially acting annular spring. The axially acting annular spring is intended for engaging or for bearing on the radial rim to urge the radial rim towards the transverse flange of outer annular piston 27 in an axial direction. In this manner, the first clutch bearing 36 is retained axially or is secured relative to the outer annular piston 27.

Similarly, the inner annular piston 33 can comprise a transverse flange for engaging or for bearing on the second clutch bearing 37. The second clutch bearing 37 can also include a radial rim and an axially acting annular spring. The axially acting annular spring is intended for engaging or for bearing on the radial rim to urge the radial rim towards the transverse flange of inner annular piston 33 in an axial direction. In this way, the second clutch bearing 37 is retained axially relative to the inner annular piston 33. In short words, the concentric slave cylinders assembly 21 actuates the two clutches of a Dual Clutch Transmission using a hydraulic system. The concentric slave cylinders assembly 21 is located in the clutch casing 16 as well as being fixed to the clutch casing 16. Each annular piston 27 or 33 of the slave cylinders assembly 21 applies or actuates the two clutches and release the two clutches through the application or release bearings 36 and 37. Oil under adequate pressure is injected into the annular chambers 30 and 34 of the concentric slave cylinders assembly 21.

This embodiment operates the clutches in an innovative manner and requires less space in comparison with other piston actuation implementation. The embodiment also avoids usage of levers to actuate the clutches.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Thus, the scope of the embodiments should be determined by the claims, rather than by the examples given. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A clutch actuation device for dual clutches of a Dual Clutch Transmission, the clutch actuation device comprising:
a cylinder assembly fixed to a clutch casing, the cylinder assembly comprising:
an inner chamber adapted to receive liquid under pressure, the inner chamber comprises an inner inlet;
an outer chamber adapted to receiving liquid under pressure, the outer chamber comprises an outer inlet, at least a portion of the inner chamber surrounded by the outer chamber;
an inner piston slidably disposed in the inner chamber and adapted to actuate a first clutch disc; and
an outer piston slidably disposed in the outer chamber and adapted to actuate a second clutch disc.

2. The clutch actuation device of claim 1, further comprising:
a pump adapted to supply liquid under pressure to the outer chamber and to the inner chamber; and
an operating valve adapted to control pressure of the liquid to selectively engage at least one of the outer piston or the inner piston and to release of the other.

3. The clutch actuation device of claim 2, further comprising:
a liquid source;
a pressure relief valve arranged with the operating valve such that a predetermined clutch actuation pressure is established in a chamber of an engaged piston; and
a conduit connected to the pressure relief valve and to the liquid source such that a relatively lower pressure is established in a chamber of an unengaged piston.

4. The clutch actuation device of claim 1, further comprising:
an inner piston seal substantially fixed to the inner piston; and
an outer piston seal substantially fixed to the outer piston,
wherein the inner piston seal and the outer piston seal substantially prevents leaking.

5. A clutch actuation device for a Dual Clutch Transmission having a first clutch and a second clutch, the clutch actuation device comprising:
a cylinder assembly comprising:
a first hydraulic motor adapted to actuate the first clutch of the Dual Clutch Transmission; and
a second hydraulic motor adapted to actuate the second clutch of the Dual Clutch Transmission;
wherein the first hydraulic motor and the second hydraulic motor are arranged such that at least a part of the first hydraulic motor is enclosed by the second hydraulic motor.

6. The clutch actuation device of claim 5,
wherein the first hydraulic motor comprises:
an inner liquid chamber; and
an inner piston disposed in the inner liquid chamber,
wherein the second hydraulic motor comprises:
an outer liquid chamber; and
an outer piston disposed in the outer liquid chamber, and wherein at least a part of an inner chamber is enclosed by an outer chamber.

7. The clutch actuation device of claim 5, wherein the cylinder assembly is substantially fixed to a clutch casing.

8. A dual clutch transmission, comprising:
an inner input shaft;
a first clutch disc connected to the inner input shaft;
a first gearwheel being provided on the inner input shaft;
an outer input shaft;
a second clutch disc being connected to the outer input shaft;
a second gearwheel being on the outer input shaft,
wherein the inner input shaft and the outer input shaft are arranged such that at least a portion of the inner input shaft is surrounded by the outer input shaft; and
a clutch actuation device adapted to selectively actuate the first clutch disc and the second clutch disc to engage a combustion engine, the clutch actuation device comprising:
a cylinder assembly fixed to a clutch casing, the cylinder assembly comprising:
an inner chamber adapted to receive liquid under pressure, the inner chamber comprises an inner inlet;
an outer chamber adapted to receiving liquid under pressure, the outer chamber comprises an outer inlet, at least a portion of the inner chamber surrounded by the outer chamber;
an inner piston slidably disposed in the inner chamber and adapted to actuate the first clutch disc; and
an outer piston slidably disposed in the outer chamber and adapted to actuate the second clutch disc.

9. The dual clutch transmission of claim 8, said clutch actuation device, further comprising:
a pump adapted to supply liquid under pressure to the outer chamber and to the inner chamber; and
an operating valve adapted to control pressure of the liquid to selectively engage at least one of the outer piston or the inner piston and to release of the other.

10. The dual clutch transmission of claim 9, said clutch actuation device further comprising:
a liquid source;
a pressure relief valve arranged with the operating valve such that a predetermined clutch actuation pressure is established in a chamber of an engaged piston; and
a conduit connected to the pressure relief valve and to the liquid source such that a relatively lower pressure is established in a chamber of an unengaged piston.

11. The dual clutch transmission of claim 8, said clutch actuation device further comprising:
an inner piston seal substantially fixed to the inner piston; and
an outer piston seal substantially fixed to the outer piston,
wherein the inner piston seal and the outer piston seal substantially prevents leaking.

12. A powertrain, comprising:
an internal combustion engine; and
a Dual Clutch Transmission selectively engageable to the internal combustion engine, the Dual Clutch Transmission comprising:
an inner input shaft;
a first clutch disc connected to the inner input shaft;
a first gearwheel being provided on the inner input shaft;
an outer input shaft;
a second clutch disc being connected to the outer input shaft;
a second gearwheel being on the outer input shaft,
wherein the inner input shaft and the outer input shaft are arranged such that at least a portion of the inner input shaft is surrounded by the outer input shaft; and
a clutch actuation device adapted to selectively actuate the first clutch disc and the second clutch disc to engage a combustion engine, the clutch actuation device comprising:
a cylinder assembly fixed to a clutch casing, the cylinder assembly comprising:
an inner chamber adapted to receive liquid under pressure, the inner chamber comprises an inner inlet;
an outer chamber adapted to receiving liquid under pressure, the outer chamber comprises an outer inlet, at least a portion of the inner chamber surrounded by the outer chamber;
an inner piston slidably disposed in the inner chamber and adapted to actuate the first clutch disc; and
an outer piston slidably disposed in the outer chamber and adapted to actuate the second clutch disc.

13. The powertrain of claim 12, said clutch actuation device, further comprising:
a pump adapted to supply liquid under pressure to the outer chamber and to the inner chamber; and
an operating valve adapted to control pressure of the liquid to selectively engage at least one of the outer piston or the inner piston and to release of the other.

14. The powertrain of claim 13, said clutch actuation device further comprising:
a liquid source;
a pressure relief valve arranged with the operating valve such that a predetermined clutch actuation pressure is established in a chamber of an engaged piston; and
a conduit connected to the pressure relief valve and to the liquid source such that a relatively lower pressure is established in a chamber of an unengaged piston.

15. The powertrain of claim 12, said clutch actuation device further comprising:
an inner piston seal substantially fixed to the inner piston; and
an outer piston seal substantially fixed to the outer piston,
wherein the inner piston seal and the outer piston seal substantially prevents leaking.
